(19) United States
(12) Patent Application Publication
(10) Pub. No.: US 2026/0167894 A1
(43) Pub. Date: Jun. 18, 2026

(54) CLEANING FOAMING TABLET AND MANUFACTURING METHOD THEREOF

(71) Applicant: FT INTERNATIONAL CO., LTD., Taichung City (TW)

(72) Inventor: Min Hung CHEN, Taichung City (TW)

(21) Appl. No.: 19/416,584

(22) Filed: Dec. 11, 2025

(30) Foreign Application Priority Data
Dec. 12, 2024 (TW) 113148462

(51) Int. Cl. C11D 1/83; C11D 3/10; C11D 3/12; C11D 3/20; C11D 3/22; C11D 3/37; C11D 3/384; C11D 17/00

(52) U.S. Cl. CPC C11D 1/83; C11D 3/10; C11D 3/1253; C11D 3/2065; C11D 3/2079; C11D 3/2086; C11D 3/222; C11D 3/3753; C11D 3/384; C11D 17/0086; C11D 2111/12

(57) ABSTRACT

The present invention provides a cleaning foaming tablet, and based on the total weight of the cleaning foaming tablet, the formulation includes: 5 wt % to 50 wt % of polyvinyl alcohol, 10 wt % to 20 wt % of sodium percarbonate, 10 wt % to 30 wt % of sodium bicarbonate, 10 wt % to 20 wt % of citric acid, 1 wt % to 10 wt % of a nonionic surfactant, 0.1 wt % to 10 wt % of stearic acid, and 1 wt % to 10 wt % of glycerol. The cleaning foaming tablet prepared from this formulation can rapidly dissolve upon contact with water, exhibits excellent cleaning performance, and reduces detergent residue. The cleaning foaming tablet is resistant to breakage in humid environments, providing good storability. In addition, the present invention also provides a method for manufacturing the cleaning foaming tablet.

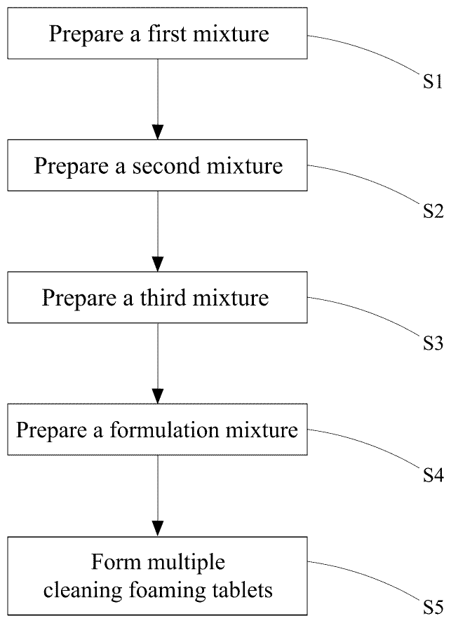

### FIELD OF INVENTION

The present invention relates to a detergent composition, particularly to a cleaning foaming tablet.

### BACKGROUND OF THE INVENTION

In the prior art, cleaning tablets used for laundry are typically produced by compression molding at room temperature. These tablets dissolve slowly and often leave detergent residues after the completion of the washing process. In addition, cleaning tablets produced in this manner are prone to breakage when exposed to moisture, making them difficult to store and carry.

### SUMMARY OF THE INVENTION

Therefore, the present invention has developed a cleaning foaming tablet to address the abovementioned problems, improving upon previous cleaning tablets that are prone to moisture-induced breakage, difficult to carry, and slow to dissolve. The objective of the present invention is to provide a cleaning foaming tablet, wherein based on the total weight of the cleaning foaming tablet, the formulation comprises: 5 wt % to 50 wt % of polyvinyl alcohol, 10 wt % to 20 wt % of sodium percarbonate, 10 wt % to 20 wt % of citric acid, 0.1 wt % to 10 wt % of stearic acid, 1 wt % to 10 wt % of glycerol, and a surfactant.

Wherein, the surfactant comprises at least sodium bicarbonate and a nonionic surfactant, wherein the sodium bicarbonate is present in an amount of 10 wt % to 30 wt %, and the nonionic surfactant is present in an amount of 1 wt % to 10 wt %.

Another objective of the present invention is to provide a method for manufacturing the cleaning foaming tablet as described above, the method comprising the following steps.

Step S1 is to stir and uniformly mix the glycerol and the surfactant under a first mixing temperature of 70° C. to 80° C. and a first rotation speed of 100 rpm to 200 rpm to form a first mixture.

Step S2 is to subsequently add a decorative material and the stearic acid to the first mixture and continue stirring at the first mixing temperature and the first rotation speed to form a second mixture.

Step S3 is to add an antibacterial agent and the polyvinyl alcohol to the second mixture and continue stirring under a second mixing temperature not exceeding 50° C. and a second rotation speed of 50 rpm to form a third mixture.

Step S4 is to add the sodium percarbonate, the sodium bicarbonate, the citric acid, a thickening agent, and a functional material to the third mixture and continue stirring at the second mixing temperature and the second rotation speed to form a formulation mixture.

Step S5 is to tablet the formulation mixture to form multiple cleaning foaming tablets, each of the cleaning foaming tablets having a weight between 3 grams and 5 grams.

The effects of the present invention are as follows: the formulation, through the addition of polyvinyl alcohol, glycerol, the thickening agent, and the functional material, and through interactions with the other components, provides an elastic texture to the cleaning foaming tablet. As a result, the cleaning foaming tablet is resistant to breakage even in humid environments, providing good storage stability. The cleaning foaming tablet prepared from this formulation exhibits a good dissolution rate when in contact with water, rapidly dissolves with minimal powder residue, and achieves sufficiently effective cleaning performance at a lower usage amount, thereby reducing material costs. In addition, the polyvinyl alcohol is an environmentally friendly material with water solubility and good biodegradability, enabling the cleaning foaming tablet to achieve environmental protection effects.

### BRIEF DESCRIPTION OF THE DRAWINGS

The FIGURE is a schematic flowchart of a preferred embodiment of a manufacturing method in accordance with the present invention.

### DETAILED DESCRIPTION OF THE PREFERRED EMBODIMENTS

The present invention discloses a cleaning foaming tablet, wherein the formulation of the cleaning foaming tablet contains no added water. Based on the total weight of the cleaning foaming tablet, the formulation includes: 5 wt % to 50 wt % of polyvinyl alcohol (PVA), 10 wt % to 20 wt % of citric acid, 10 wt % to 20 wt % of sodium percarbonate, 1 wt % to 10 wt % of glycerol, 0.1 wt % to 10 wt % of stearic acid, and 1 wt % to 10 wt % of a surfactant.

The surfactant includes at least sodium bicarbonate (baking soda) and a nonionic surfactant. The sodium bicarbonate is present in an amount of 10 wt % to 30 wt %, and the nonionic surfactant is present in an amount of 1 wt % to 10 wt %.

The nonionic surfactant may be selected from natural nonionic surfactants.

The molecular weight of the polyvinyl alcohol (PVA) ranges from 14,000 g/mole to 120,000 g/mole.

In detail, the citric acid can achieve the effects of removing grease and eliminating odors.

In a first embodiment, the formulation may, based on requirements, further include 0.1 wt % to 30 wt % of a functional material to provide effects such as disinfection, bleaching, color development, or cleaning. The functional material may be selected from an enzymatic decomposer, an anti-fouling agent, a water softening agent, an elasticity modifier, and a whitening agent, wherein at least one is included.

The enzymatic decomposer is selected from at least one of a cellulase and a protease for collar stain decomposition. The anti-fouling agent is a anti-resoling agent (MACP). The water softening agent is a zeolite. The elasticity modifier is potassium hydroxide. The whitening agent is selected from at least one of a fluorescent whitening agent (FWA) and a peroxide cleaning factor (PCS). In the first embodiment, the surfactant further includes an anionic surfactant, selected from anionic linear alkylbenzenesulfonates (LAS).

Preferably, the functional material includes the elasticity modifier, and the effervescence modifier is present in an amount of 0.1 wt % to 10 wt %, for adjusting the hardness and elasticity properties of the cleaning foaming tablet.

In a second embodiment, the formulation may, based on requirements, further include a thickening agent to increase the viscosity of the cleaning foaming tablet and to control the surface hardness after forming. Furthermore, in the second embodiment, through the addition of the thickening agent and the polyvinyl alcohol, as well as the proportion of the components, the cleaning foaming tablet can exhibit a elastic tactile feel and maintaining sufficient viscosity to prevent easy crumbling or breakage.

The thickening agent may be selected from at least one of sodium alginate 10 wt % to 15 wt %, starch 1 wt % to 10 wt %, and talc 1 wt % to 10 wt %.

In other embodiments, the formulation includes the thickening agent and the elasticity modifier (potassium hydroxide). In this embodiment, the thickening agent is used to increase the viscosity of the cleaning foaming tablet, and the elasticity modifier is used to control the surface hardness after forming. Furthermore, the thickening agent and the elasticity modifier cooperate with the polyvinyl alcohol to provide the cleaning foaming tablet with an elastic tactile feel while preventing easy crumbling or breakage.

In a third embodiment, the formulation may, based on requirements, further include an antibacterial agent.

The antibacterial agent is selected from calcined oyster shell powder in an amount of 1 wt % to 30 wt %, which has antibacterial and anti-inflammatory effects.

In a fourth embodiment, the formulation may, based on requirements, further include a decorative material to enhance the fragrance and color of the cleaning foaming tablet. The decorative material may be a fragrance, a colorant, or a combination thereof. The fragrance is present in an amount of 0.01 wt % to 0.05 wt %, and the colorant is present in an amount of 0.01 wt % to 0.05 wt %.

In other embodiments, the formulation of the cleaning foaming tablet may, as required, further include at least two of the functional material, the thickening agent, the antibacterial agent, and the decorative material. For example, the formulation may simultaneously include the decorative material and the antibacterial agent, and is not limited to the examples described in the foregoing embodiments.

With reference to the FIGURE, the following describes the manufacturing method disclosed in accordance with the present invention, in which the cleaning foaming tablet is produced using the aforementioned formulation, and the method includes the following steps S1 to S5.

In step S1, the glycerol and the surfactant are first stirred under conditions of a first mixing temperature of 70° C. to 80° C. and a first rotation speed of 100 rpm to 200 rpm for 3 to 5 minutes to achieve uniform mixing, forming a first mixture, wherein the first mixture is in a liquid state.

Next, in step S2, the decorative material and the stearic acid are added and mixed with the first mixture, and stirring is continued at the first mixing temperature and the first rotation speed for 3 to 5 minutes to form a second mixture, wherein the second mixture is in a liquid state.

In step S3, the antibacterial agent and the polyvinyl alcohol are added and mixed with the second mixture, and stirring is continued under conditions of a second mixing temperature not exceeding 50° C. and a second rotation speed of 50 rpm for 3 to 5 minutes to form a third mixture, wherein the third mixture is in a solid state.

In step S4, the sodium percarbonate, sodium bicarbonate, citric acid, thickening agent, and functional material are added and mixed with the third mixture, and stirring is continued at the second mixing temperature and the second rotation speed for 3 to 5 minutes to form a formulation mixture, wherein the formulation mixture is in a solid state. The thickening agent is selected from talc.

Finally, in step S5, the formulation mixture is fed into a tablet press and compressed under a tablet pressure of 5,000 kg to 10,000 kg and a tablet temperature of 30° C. to 50° C. to form multiple cleaning foaming tablets, each having an average weight of 3 grams to 5 grams.

The shape, color, and fragrance of the cleaning foaming tablets are not limited. For example, the cleaning foaming tablets may have a rose scent and a bear-shaped appearance.

It is noteworthy that during the mixing process in step S5, the addition of talc, sodium bicarbonate, and sodium percarbonate creates an alkaline environment, in which esters (such as stearic esters) undergo a hydrolysis reaction. Furthermore, since the tablet forming process is carried out under the tablet temperature and pressure conditions, oils and alkalis are generated within the formulation mixture during tablet formation, resulting in a saponification reaction. This reaction facilitates the forming of the formulation mixture and enables the obtained cleaning foaming tablets to exhibit an elastic tactile feel.

The properties of the polyvinyl alcohol (PVA) and glycerol enable the formulation mixture to be plasticized and promote the formation of the cleaning foaming tablets. The elasticity modifier and the thickening agent contained in the functional material further cooperate with the polyvinyl alcohol to provide the cleaning foaming tablets with a elastic tactile feel and prevent breakage after tablet formation. Furthermore, the glycerol and the surfactant, in the absence of added water, assist in forming the formulation mixture to obtain the cleaning foaming tablets.

When the foaming tablets are dissolved in water for laundry cleaning, the glycerol in the formulation of the cleaning foaming tablets also provides a stain removal effect. In addition, the sodium percarbonate reacts with water to generate hydrogen peroxide, and the nonionic surfactant in the cleaning foaming tablets reduces the surface tension of water, facilitating penetration into fabric fibers to remove stains adhered to the fibers. Through the interaction of the hydrophilic and lipophilic ends of its molecular structure with the dirt, when the critical micelle concentration is reached and micelles are formed, the dirt can be more effectively removed, achieving a cleaning effect.

Furthermore, when the cleaning foaming tablet is mixed with water, the glycerol and the surfactant contained in the cleaning foaming tablet can promote the decomposition reaction of the sodium percarbonate, citric acid, and sodium bicarbonate (baking soda), thereby accelerating the dissolution rate of the cleaning foaming tablet.

Furthermore, compared to commercially available cleaning tablets, the inclusion of polyvinyl alcohol (PVA), glycerol, and stearic esters in this embodiment significantly improves the structural stability of the cleaning foaming tablet. Even in a humid environment, the cleaning foaming tablet is not easily broken, which enhances its storability. Therefore, under the same storage conditions, the cleaning foaming tablet of this embodiment exhibits greater structural stability.

With reference to TABLE 1, which presents an experimental analysis, a dissolution test was conducted comparing the cleaning foaming tablet of this embodiment with cleaning tablets of various comparative examples to demonstrate the effects achieved by the present invention. Each comparative example was selected from different commercially available brands of cleaning tablets: the first comparative example is a product of the blueland brand; the second comparative example is a product of the Myni brand; and the third comparative example is a product of the REVOLU BAR brand. To verify the performance of the present invention, the experimental results are described in detail below. The dissolution test was conducted in water at room temperature (23° C.). The cleaning foaming tablet of this embodiment and each comparative product were separately dissolved in the same weight of water to measure the dissolution rate. After dissolution, the solution was poured out to observe whether any residue remained.

As shown in Table 1, the unit weight of the cleaning foaming tablet of this embodiment (average 3 g per tablet) is significantly lower than that of the other comparative examples. In addition, according to the test results for each comparative example and this embodiment, the dissolution times of the second and third comparative examples both exceeded 50 minutes. Such a slow dissolution rate indicates that when using the products of the second and third comparative examples for laundry, detergent residues may remain after washing, adversely affecting the cleaning performance.

Although the dissolution rate of the first comparative example is faster than that of the second and third comparative examples, its dissolution time may still result in detergent residue. In contrast, the dissolution time of the cleaning foaming tablet of this embodiment is significantly shorter, effectively solving the problem of detergent residue.

Furthermore, the cleaning foaming tablet of the embodiment has a unit weight (an average of 3 g per tablet) significantly lower than that of the products in the comparative examples, but it can still provide sufficient cleaning performance. This not only reduces manufacturing costs but also shortens the washing process time under rapid dissolution conditions without leaving any residue, making it more suitable for the quick wash mode of washing machines.

The formulation and manufacturing method of the cleaning foaming tablet in accordance with the present invention have the following advantages:
1. The cleaning foaming tablet can achieve a sufficiently effective cleaning performance with a smaller amount of use, thereby reducing material costs.
2. Due to the addition of polyvinyl alcohol (PVA) and glycerol, the cleaning foaming tablet exhibits an elastic texture and remains resistant to cracking even when exposed to humid environments, thereby providing excellent storage stability.
3. The polyvinyl alcohol (PVA) used in the cleaning foaming tablet is an environmentally friendly material with water solubility and excellent biodegradability, thereby achieving the effect of environmental protection.
4. The cleaning foaming tablet exhibits a good dissolution rate when in contact with water, quickly dissolving with minimal powder residue.

TABLE 1

| | First | Second | Third | |
|---|---|---|---|---|
| | comparative | comparative | comparative | This |
| | example | example | example | embodiment |
| Weight | 6.1 grams | 6.25 grams | 6.75 grams | 3 grams |
| Dissolving | in water at | in water at | in water at | in water at |
| time | room | room | room | room |
| | temperature | temperature | temperature | temperature |
| | 23° C. | 23° C. | 23° C. | 23° C. |
| | 9 minutes 30 | more than 50 | more than 50 | 2 minutes 30 |
| | seconds | minutes | minutes | seconds |
| Residue | Yes | Yes | Yes | No |
| remains | | | | |

What is claimed is:

1. A cleaning foaming tablet, wherein based on the total weight of the cleaning foaming tablet, a formulation of the cleaning foaming tablet comprises:
polyvinyl alcohol, in an amount of 5 wt % to 50 wt %;
sodium percarbonate, in an amount of 10 wt % to 20 wt %;
citric acid, in an amount of 10 wt % to 20 wt %;
stearic acid, in an amount of 0.1 wt % to 10 wt %;
glycerol, in an amount of 1 wt % to 10 wt %; and
a surfactant,
wherein the surfactant comprises at least a sodium bicarbonate in an amount of 10 wt % to 30 wt % and a nonionic surfactant in an amount of 1 wt % to 10 wt %.

2. The cleaning foaming tablet according to claim 1, wherein the formulation further comprises at least one of an antibacterial agent and a thickening agent, wherein the antibacterial agent being selected from calcined oyster shell powder, the thickening agent being selected from at least one of sodium alginate, starch, and talc, wherein the calcined oyster shell powder is present in an amount of 1 wt % to 30 wt %, the sodium alginate is present in an amount of 10 wt % to 15 wt %, the starch is present in an amount of 1 wt % to 10 wt %, and the talc is present in an amount of 1 wt % to 10 wt %.

3. The cleaning foaming tablet according to claim 1, wherein the formulation further comprises a decorative material, the decorative material comprising at least one of a fragrance and a colorant, wherein the fragrance is present in an amount of 0.01 wt % to 0.05 wt %, and the colorant is present in an amount of 0.01 wt % to 0.05 wt %.

4. The cleaning foaming tablet according to claim 1, wherein the formulation further comprises a functional material, the functional material being present in an amount of 0.1 wt % to 30 wt % and selected from at least one of an enzymatic decomposer, an anti-fouling agent, a water softening agent, an elasticity modifier, and a whitening agent.

5. The cleaning foaming tablet according to claim 1, wherein the surfactant further comprises an anionic surfactant.

6. The cleaning foaming tablet according to claim 2, wherein the surfactant further comprises an anionic surfactant.

7. The cleaning foaming tablet according to claim 3, wherein the surfactant further comprises an anionic surfactant.

8. The cleaning foaming tablet according to claim 4, wherein the surfactant further comprises an anionic surfactant.

9. The cleaning foaming tablet according to claim 1, wherein the polyvinyl alcohol has a molecular weight of 14,000 g/mole to 120,000 g/mole.

10. A method for manufacturing a cleaning foaming tablet, for preparing the cleaning foaming tablet according to claim 1, the method comprising:
Step S1, stirring and uniformly mixing the glycerin and the surfactant under a first mixing temperature of 70° C. to 80° C. and a first rotation speed of 100 rpm to 200 rpm to form a first mixture;
Step S2, adding the stearic acid to the first mixture and mixing under the first mixing temperature and the first rotation speed to form a second mixture;
Step S3, the polyvinyl alcohol to the second mixture and mixing under a second mixing temperature not higher than 50° C. and a second rotation speed of 50 rpm to form a third mixture;
Step S4, adding the sodium percarbonate, the sodium bicarbonate and the functional material to the third mixture and mixing under the second mixing temperature and the second rotation speed to form a formulation mixture; and
Step S5, tableting the formulation mixture to form multiple cleaning foaming tablets, each of the cleaning foaming tablets having a weight between 3 grams and 5 grams.

11. A method for manufacturing a cleaning foaming tablet according to claim 10, wherein the method further comprising:
adding a decorative material in Step S2;
adding an antibacterial agent in Step S3; and
adding a thickener and a functional material in Step S4.
